(19) United States
(12) Patent Application Publication
(10) Pub. No.: US 2001/0006092 A1
(43) Pub. Date: Jul. 5, 2001

(54) Method for producing an electrochromic mirror

(75) Inventors: Keizo Ikai, Yokohama-shi (JP); Masaaki Kobayashi, Yokohama-shi (JP); Tsuhoshi Asano, Yokohama-shi (JP); Yoshinori Nishikitani, Yokohama-shi (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Nippon Mitsubishi Oil Corporation

(21) Appl. No.: 09/749,015

(22) Filed: Dec. 27, 2000

(30) Foreign Application Priority Data
Dec. 28, 1999 (JP) 11-374345

(51) Int. Cl. C09J 5/06; C03C 27/12; C03B 25/00

(52) U.S. Cl. 156/330; 65/41; 65/43

(57) ABSTRACT

A method for producing an electrochromic mirror comprises a step of obtaining an electrochromic mirror cell by laminating two electrically conductive substrates applied with a sealant on the peripheral edge of the conductive surface; a step of sealing the cell after injecting an electrolyte therein; and annealing the cell containing the electrolyte.

### BACKGROUND OF THE INVENTION

1. Field of the Invention

This invention relates to a method for producing an electrochromic mirror which is capable of reversibly varying reflectance to electromagnetic radiation such as light.

2. Description of the Prior Art

Electrochromic anti-glare mirrors have been used for glare-protection purposes from light emanating from the headlights of vehicles approaching from the rear by reversibly varying reflectance to electromagnetic radiation. Demand for such electrochromic anti-glare mirrors has gone up sharply in recent years.

In general, an electrochromic mirror is comprised of a cell in which an electrolyte and if necessary an electrochromic compounds are sealingly contained, an optical sensor, a controlling electric circuit, and a case accommodating these components. The cell is usually formed by placing two electrically conductive substrates each comprised of a glass substrate and a conductive layer formed thereon, with their conductive surfaces facing each other, and laminating the substrates with a sealant. As the sealant, epoxy-based sealants have been used.

As a result of a search conducted by the present inventors, it has been found that a cell was frequently deteriorated in performances, such as insufficient or no coloration occurring along the sealed surface of the conductive substrate, resulting from the contamination of the conductive surfaces.

Therefore, an object of the present invention is to provide a method for producing an electrochromic mirror which can prevent the conductive layer from being contaminated and improve the performances of the cell.

After an extensive research and development, it has been found that a cell sealingly containing an electrolyte was subjected to annealing whereby the contamination of a conductive layer can be avoided and the cell performances can be improved. According to the research, the contamination of a conductive surface has been considered to be caused by the low molecular weight components contained in a sealant in an uncured state and ones developed during the thermal curing of the sealant. Assumedly, the annealing of a cell causes the efficient diffusion or dissolution of such components in an electrolyte, and thus can prevent a conductive surface from being contaminated.

### SUMMARY OF THE INVENTION

According to the present invention, there is provided a method for producing an electrochromic mirror comprising a step of obtaining an electrochromic mirror cell by laminating two electrically conductive substrates applied with a sealant on the peripheral edge of the conductive surface; a step of sealing the cell after injecting an electrolyte therein; and annealing the cell containing the electrolyte.

### DETAILED DESCRIPTION OF THE INVENTION

The method of the present invention is described in the order of the steps.

Firstly, an electrochromic mirror cell is produced by laminating two electrically conductive substrates applied on the peripheral edge of the conductive surface with a sealant.

The followings are descriptions of the electrically conductive substrates which may be hereinafter referred to as merely “substrate”.

The term “electrically conductive substrates” used herein designates ones which act as electrodes. Therefore, the conductive substrate used in the present invention encompasses a substrate which itself is made from an electrically conductivity material, or a laminate formed by laminating an electrode layer on one or both of the surfaces of a non-electrically conductive substrate. Regardless of whether a substrate has electrically conductive or not, it necessarily has a smooth surface at normal temperature but may have a flat or curved surface and may be deformable under stress. The substrates generally have the same shape but may have a different shape as well. Although not restricted, the thickness of the substrate is usually from 0.2 to 2.5 mm.

One of the two conductive substrates is transparent and the other is a reflective conductive substrate which can reflect electromagnetic waves, typically lights.

The term “transparent” used herein denotes an optical transmissivity of 10 to 100% in visible light region. No particular limitations is imposed on the materials for such a transparent substrate. It may thus be a color or colorless glass, a reinforced glass and a resin of color or colorless transparency. Specific examples of such a resin include polyethylene terephthalate, polyamide, polysulfone, polyether sulfone, polyether etherketone, polyphenylene sulfide, polycarbonate, polyimide, polymethyl methacrylate, and polystyrene.

Eligible materials for the transparent electrode layer may be a thin film of metal such as gold, silver, chrome, copper and tungsten or metal oxides such as ITO (In₂O₃—SnO₂), tin oxide, silver oxide, zinc oxide and vanadium oxide. The electrode layer has a film thickness in the range of usually 10 to 500 nm and preferably 50 to 300 nm. The surface resistance, i.e., resistance per unit area, of the electrode is usually in the range of 0.5 to 500 Ω/sq and preferably 1 to 50 Ω/sq. Any suitable known method for forming the electrode layer on the transparent substrate can be employed.

The reflective electrically conductive substrate may be exemplified by (1) a laminate comprising a non-conductive transparent or opaque substrate and a reflective electrode layer formed thereon, (2) a laminate comprising a non-conductive transparent substrate having a transparent electrode layer on one of its surfaces and a reflective electrode layer on the other surface, (3) a laminate comprising a non-conductive transparent substrate having a reflective layer formed thereon and further a transparent electrode layer formed thereon, (4) a laminate comprising a reflective substrate and a transparent electrode layer formed thereon, and (5) a plate-like substrate which itself functions as a reflective layer and an electrode.

The term “reflective electrode layer” used herein denotes a thin film which has a specular surface and is stable electrochemically. Such a thin film are the films of metal such as gold, platinum, tungsten, tantalum, rhenium, osmium, iridium, silver, nickel and palladium and the film of an alloy such as platinum-palladium, platinum-rhodium and stainless steel. Any suitable method may be used for the formation of the thin film having a specular surface, and thus vacuum deposition, ion-plating or sputtering is suitably selected. A substrate for the reflective conductive layer may or may not be transparent. Therefore, the substrate may be the above-exemplified transparent substrates, and various opaque plastics, glasses, woods, and stones as well. In the case where the above-described reflective electrode layer itself has rigidity, a substrate therefor may be omitted.

The above-mentioned reflective plate and reflective layer are substrates and thin films both of which have a specular surface. The plate and layer may be a plate or a thin film, formed from silver, chrome, aluminum, stainless steel, and nickel-chrome.

The substrate may have an electrochromic compound layer or a layer containing an electrochromic compound formed thereon. In this case, an electrolyte to be injected into a cell may not contain an electrochromic compound described below.

A sealant used in the present invention may be selected from epoxy-based sealants which have been widely used for the production of a liquid crystal display. The sealant may be thermally curing type or photo-curing type cured by the irradiation of ultraviolet or visible light.

Specific examples of such epoxy-based sealants are bisphenol A type epoxy resin, bisphenol F type epoxy resin, biphenyl type epoxy resin, bisphenol S type epoxy resin, diphenylether type epoxy resin, dicyclopentadiene type epoxy resin, bromine-containing bisphenol F type epoxy resin, fluorine-containing bisphenol A type epoxy resin, orthocresolnovolak type epoxy resin, DPP novolak type epoxy resin, trishydroxyphenylmethane type epoxy resin, tetraphenylolethane type epoxy resin, dicylopentadienophenol type epoxy resin, glycidylamine type epoxy resin, glycidyl ester type epoxy resin, alicyclic type epoxy resin, urethane-modified epoxy resin, and silicone-containing epoxy resin.

Specific examples of the thermally-curing sealant are ones cured only with an epoxy resin and ones cured with a curing agent to be added therein. Sealants of which the epoxy resin is cured is mixed with a catalytic curing agent. Specific examples of the catalytic curing agent are benzylsulfonium salt, benzylammonium salt, pyridinium salt, benzylphosphonium salt, hydrazinium salt, carboxylate, sulfonate, and amineimide. Specific examples of the curing agent to be mixed with a sealant are amine-based curing agents such as diethylenetriamine, triethylenetetramine, menthendiamine, isophoronediamine, methaxylenediamine, diaminodiphenylmethane, methaphenylenediamine, diaminodiphenylsulfone, and polyamideamine; acid anhydride curing agents such as methyltetrahydrophthalate anhydride, methylhexahydrophthalate anhydride, and methylnadic anhydride; and phenolic curing agents such as naphtol phenolic resin, dicyclopentadiene phenolic resin, and styrene phenolic resin. There may be used a latent thermally curing agent such as dicyandiamide, dihydrazide adipicate, imidazolic compounds, and an epoxy-amine adduct.

Specific examples of the photo-curing agent are the above-described epoxy resins, and epoxy-modified acrylic resins obtained by reacting the above-described epoxy resins with acrylic acid, methacrylic acid, crotonoic acid, hexylacrylic acid, or cinnamic acid. The photo-curing catalyst for the epoxy resins may be aryldiazonium salt, diaryliodinium salt, triarylsulfonium, β-ketosulfone, ininosulfonate, and benzoylsulfonate. The photo-curing catalyst for the epoxy-modified acrylic resins may be benzylmethylketal, α-hydroxyketone, and α-aminoketone.

The sealant may be mixed with beads. Beads act as spacers to keep the space, i.e., cell gap, between two conductive substrates, constant when they are laminated. The average particle size of such beads are usually from 200 to 20 μm, preferably from 150 to 30 μm, more preferably from 100 to 40 μm, and particularly preferably from 80 to 50 μm. No particular limitation is imposed on the materials for the beads as long as they have insulation properties. Therefore, there may be used (1) various glasses such as quarts glass, soda-lime glass, borosilicate glass, and lead glass, or (2) various resins such as acrylic-, polycpropylene carbonate)-, or vinylbenzene-resins. The beads may be colorless or colored and may be transparent or opaque.

When the sealant contains the beads, the content thereof is preferably from 0.01 to 10 percent by mass, more preferably from 0.05 to 5 percent by mass, and particularly preferably from 0.1 to 3 percent by mass. The sealant may contain fillers such as alumina and silica.

In the case where the beads are contained in the epoxy sealant, the viscosity thereof is preferably from 0.5 to 500 Pa.s, more preferably 2 to 300 Pa.s, and particularly preferably 5 to 150 Pa.s.

The sealant is usually applied on a predetermined place of the surface peripheral edge of one of the substrates. Needless to mention, the sealant may be applied on the surface peripheral edges of both of the substrates. The sealed portion may be provided with at least one opening through which an electrolyte or the like is injected.

In general, two conductive substrates having the same shape are used to produce an electrochromic mirror. In the case where two substrates are fittingly superposed on each other, the sealant is applied on the portion, 0.2 to 10 mm apart, from the edge of the substrate, along the shape thereof. Alternatively, in the case where two substrates are superposed, offsetting from each other in a parallel direction, the position of the sealant to be applied is adjusted depending on the direction or position to be offset.

A sealant may be applied by dispensing or screen-printing. Dispensing may be operated with a prior known device such as those equipped with discharge nozzles, nozzle-fixed heads, sealant-containing barrels, a discharge adjuster, and a plate for setting substrates. Screen-printing may be operated with a prior known device equipped with a vacuum table, a frame-switching mechanism, a squeegee-switching mechanism, a squeegee-horizontal-shifting mechanism, a screen-printing plate, and a squeegee.

After the sealant is applied on a substrate, the substrate is superposed and laminated on the other substrate, with their conductive surfaces facing each other. The two substrates may be superposed with a predetermined space, registered with each other or offsetting slightly in a parallel direction from each other. Such methods may be selected depending on an electrochromic mirror to be produced.

In order to maintain the space between two substrates constant, beads may be spread over the entire surface of the substrate. The beads have a particle size of usually from 20 to 200 μm, preferably from 30 to 150 μm, and more preferably from 40 to 100 μm but have desirously a particle size equal to that of beads contained in the sealant. No particular limitation is imposed on the materials of the beads which, therefore, may be (1) various glasses such as quarts glass, soda-lime glass, borosilicate glass, and lead glass or (2) vairous resins such as acrylic-, poly(propylene carbonate)-, or vinylbenzene-resins. The beads may be colorless or colored and may be transparent or opaque.

The beads may be spread using a sieve or by a dry-spraying method where the beads are blown with airflow. Alternatively, there may be employed a wet-spraying method where a liquid containing the beads dispersed in a solvent such as water and IPA is coated or sprayed over a substrate and dried out. In either case, the beads are preferably spread over the lower substrate. The number of beads per unit area is from 0.1 to 300 beads/cm², preferably from 0.2 to 200 beads/cm², and more preferably from 0.5 to 120 beads/cm².

The lamination of the substrates is completed by curing the sealant. The sealant is cured under the conditions suitably selected depending on the types of substrates and the sealant to be used. For example, the thermally curing sealant is heated at a temperature of usually 80 to 200° C., preferably 100 to 180° C. for one minute to 3 hours, preferably 10 minutes to 2 hours. When using the photo-curing sealant, eligible light sources are high voltage mercury lamps, fluorescent lamps and xenon lamps. Although not restricted, the irradiation dose is usually from 100 to 50,000 mJ/cm², preferably from 1,000 to 20,000 mJ/cm². Before one of the substrates is applied with the sealant and laminated on the other substrate, the sealant may be pre-cured by heating. The term “pre-cure” used herein denotes a state that the sealant is in the progress of curing, i.e., is not completely cured and fit to the substrate by being squashed when being superposed on the other substrate thereby exhibiting sufficient adhesivity.

When the substrates are laminated, they are arranged in a parallel relationship to one another. Although not restricted, the width of the cell gap is usually from 20 to 200 μm, preferably 30 to 150 μm, and more preferably from 40 to 100 μm. The width of the cell gap can be easily adjusted by selecting the particle size of the beads contained in the sealant. Alternatively, any suitable shaped spacer may be placed on the peripheral edge of the substrate in order to adjust the width of the cell gap. A sealant is preferably cured while a constant pressing force is applied to a cell. In this case, such a pressing force may be applied entirely on a cell or only on the sealed portion or the vicinity thereof. The pressing force may be applied by placing a weight on a cell, by pressing with an air bag, or by vacuuming a vacuum bag containing a cell. In the case of using a weight, the pressing force may be adjusted by the weight of itself. Alternatively, a weight connected to a spring is pushed downwardly against a cell so as to adjust the pressing force by checking how much the spring is compressed. In the case of using an air bag, the pressing force may be adjusted with the quantity of air to be contained in the bag. In the case of vacuuming an vacuuming bag containing a cell, the pressing force may be adjusted by controlling the vacuuming level. The pressing force is preferably within the range of 0.001 to 0.5 MPa. The pressing force may be applied on a single cell or 2 to 200 cells arranged side by side or superposed on one another.

An electrochromic mirror cell can be produced by following the above-described procedures.

In the next step, an electrolyte is injected through the inlet into a cell and the inlet is sealed.

The electrolyte may be selected from various known electrolytes which may be liquid, gelatinized and solid. Preferred are solid electrolytes. In the present invention, there may be used compositions obtained by mixing or reacting various electrochromic compounds with the electrolyte, which compositions are changed in physical properties by electrochromic means. As described hereinbelow, the electrolyte may be electrolyte precursors which contain an electrolyte and a polymerizable monomer and can thus be solidified by polymerization and electrolyte composition precursors which further contain an electrochromic compound mixed or reacted with an electrolyte and a polymerizable monomer. The electrolyte precursors may be of photo-curing type or thermal-curing type.

Eligible liquid electrolytes are ones dissolving a supporting electrolyte such as salts, acids, or alkalis in a solvent. No particular limitation is imposed on the solvent as long as it can dissolve the supporting electrolyte. Preferred are ones having a polarity. Specific examples of the solvent are water, and organic polar solvent such as acetic anhydride, methanol, ethanol, propylene carbonate, ethylene carbonate, dimethylsulfoxide, dimethoxyethane, acetnitrile, γ-butyrolactone, sulforan, 1,3-dioxane, N,N-dimethylformamide, 1,2-dimethoxyethane, and tetrahydrofuran. Preferred are propylene carbonate, ethylene carbonate, dimethylsulfoxide, dimethoxyethane, acetnitrile, γ-butyrolactone, sulforan, 1,3-dioxane, N,N-dimethylformamide, 1,2-dimethoxyethane, and tetrahydrofuran. These solvents may be used singlely or in combination.

No particular limitation is imposed on salts used as the supporting electrolyte, which may be inorganic ion salts such as alkali metal salts and alkaline earth metal salts, quaternary ammonium salts, and cyclic quaternary ammonium salts. Specific examples of such salts are alkali metal salts of lithium, sodium or potassium such as LiClO₄, LiSCN, LiBF₄, LiAsF₆, LiCF₃SO₃, LiPF₆, LiI, NaI, NaSCN, NaClO₄, NaBF₄, NaAsF₆, KSCN and KCl; quaternary ammonium salts or cyclic quaternary ammonium salts such as (CH₃)₄NBF₄, (C₂H₅)₄NBF₄, (n-C₄H₉)₄NBF₄, (C₂H₅)₄NBr, (C₂H₅)₄NClO₄ and (n-C₄H₉)₄NClO₄, and mixtures thereof.

No particular limitation is imposed on acids as the supporting electrolyte. Any inorganic acids and organic acids may be used. Specific examples are sulfuric acid, hydrochloric acid, phosphoric acid, sulfonic acid, and carboxylic acid.

No particular limitation is imposed on alkalis as the supporting electrolyte as well. Sodium hydroxide, potassium hydroxide, and lithium hydroxide may be used.

Eligible gelatinized electrolytes are ones obtained by adding a polymer or a gelatinizer to the above-mentioned liquid electrolyte to be viscous or gelatinized. Although not restricted, the polymer may be polyacrylonitrile, carboxymethyl cellulose, polyvinyl chloride, polyethylene oxide, polyurethane, polyacrylate, polymethacrylate, polyamide, polyacrylicamide, cellulose, polyester, polypropylene oxide, and nafion. Eligible gelatinizers are oxyethylene methacrylate, oxyethylene acrylate, urethaneacrylate, acrylicamide and agar-agar. The gelatinized electrolyte may be sandwiched between two opposing conductive substrates by injecting a mixture of a monomer, which is a precursor of the polymer, and a precursor of the gelatinizer into a cell formed by laminating two conductive substrates and then polymerizing or gelatinizing the mixture.

No particular limitation is imposed on the solid electrolytes as long as they are solid at room temperature and have ion conductivity. Specific examples of the solid electrolyte are polyethylene oxide, a polymer of oxyethylenemethacrylate, nation, polystyrene sulfonate. Particularly preferred are polymeric solid electrolyte obtained by polymerizing a precursor containing an oxyalkylene(metha)acrylate-based compound or a urethane acrylate-based compound as a main component. The solid electrolyte may be ones obtained by solidifying a precursor which is a compound containing a monofunctional acryloyl-modified polyalkylene oxide and/or a polyfunctional acryloyl-modified polyalkylene oxide, the above-mentioned organic solvent, and the above-mentioned supporting electrolyte.

No particular limitation is thus imposed on the electrochromic compound as long as it colors, decolors, and discolors by electrochemical oxidation or reduction reaction. Specific examples of the electrochromic compound are MO₂O₃, Ir₂O, NiO, V₂O₅, WO₃, viologen, polytionphene, polyaniline, polypyrrole, metal phthalocyanine, pyrazoline, phenylenediamine, phenazine, phenoxazine, phenothiazine, tetrathiafulvalene, ferrocene, and derivatives thereof.

Materials used for sealing the inlet of a cell, i.e., sealer may be photo-curing type sealants which are generally used for producing a liquid crystal display. Specific examples of such sealers are the epoxy resins exemplified with respect to the above-mentioned sealant, and epoxy-modified acrylic resins obtained by reacting the above-described epoxy resins with acrylic acid, methacrylic acid, crotonoic acid, hexylacrylic acid, or cinnamic acid. The photo-curing catalyst for the epoxy resins may be aryldiazoniumsalt, diaryliodiniumsalt, triarylsulfonium, β-ketosulfone, iminosulfonate, and benzoylsulfonate. The photo-curing catalyst for the epoxy-modified acrylic resins may be benzylmethylketal, α-hydroxyketone, and α-aminoketone. The sealer may contain filler components such as alumina and silica.

The electrolyte is preferably injected into a cell by a vacuum injection method. More specifically, a cell and a dish for an electrolyte placed into a vacuum chamber are subjected to vacuum evacuation. The electrolyte may be put in the dish after or before the vacuum evacuation. The degree of vacuum is preferably set to be from 0.001 to 100 Pa. After the interior of the chamber is evacuated, the cell is placed on the dish such that the inlet is immersed into the electrolyte. The inner pressure of the chamber is elevated, usually to atmospheric pressure but may be elevated to a level higher than that. In such a manner, the electrolyte is injected into the cell. The cell is removed from the chamber after the inner pressure of the chamber is made equal to that of the outside.

The sealing of the inlet may be done once or twice or more. A sealer is preferably sucked into the cell so as to be about 0.2 to 5 mm in height extending from the inner edge of the inlet. For this operation, before the sealer is applied in the inlet, it is effective to discharge a proper quantity of the electrolyte by pressing the cell in the surface direction and suck the sealer into the cell by weakening the pressing force appropriately. Pressing the cell surfaces is effectively conducted by squeezing the cell with undeformable metal blocks or by pressing the cell with an air bag. In the case of using such metal blocks, the pressing force is adjusted by pressing the metal blocks with a spring and checking how much it is compressed. In the case of using an air bag, the pressing force is adjusted with the quantity of air to be contained in the bag. The pressing force may be applied on the cell surface using a vacuum bag. In this case, the pressing force is adjusted by the degree of vacuum. The pressing force is preferably within the range of 0.001 to 0.1 MPa. When pressing the cell surfaces, the pressing force may be applied onto a single cell or 2 to 200 cells arranged side by side or superposed on one another.

Following this procedure, the cell containing the electrolyte is subjected to an annealing treatment. The annealing treatment is conducted with the electrolyte shielded from the outside and maintained unchanged. More specifically, the anneal treatment is conducted at a temperature at which the lower molecular weight components from the sealant can diffuse or dissolve in the electrolyte and the electrolyte and the other components do not change in nature.

The anneal treatment may be conducted by either one of the following methods.

(1) Putting a cell or a cell and a part of or all of the other components forming an electrochromic mirror, such as an optical sensor, a controlling electric circuit, and a case accommodating them, in an oven,

(2) Placing a cell or a cell and a part of or all of the other components forming an electrochromic mirror, such as an optical sensor, a controlling electric circuit, and a case accommodating them, on a hot plate,

(3) Irradiating a cell or a cell and a part of or all of the other components forming an electrochromic mirror, such as an optical sensor, a controlling electric circuit, and a case accommodating them, with a halogen lump or a infrared or far infrared lump.

(1) Annealing Treatment Using An Oven

In the case of using an oven, there are two methods, one of in which a cell is put into an oven, the inside of which maintained at a certain temperature and the other of in which a cell is put into an oven and heated to a certain temperature. Either one of the methods may be suitably employed. The temperature in an oven is usually from 40 to 160° C., preferably from 50 to 130° C., and more preferably from 60 to 100° C. In the case of putting a cell into an oven maintained at a certain temperature, the time of heating a cell in an oven is selected suitably, depending on the type of sealant and heating temperature but is usually from 1 minute to 50 hours, preferably from 5 minutes to 30 hours, and more preferably from 10 minutes to 24 hours. In the case of heating to a certain temperature, the heating rate is usually from 0.5 to 10° C./minute, preferably from 1 to 7° C./minute, and more preferably from 1 to 5° C./minute. In this case, the temperature once reached at a certain level may be then maintained for usually 50 hours or shorter, preferably 30 hours or shorter, and more preferably 24 hours or shorter and 0.1 hours or longer.

In either case, a cell may be removed from an oven immediately after the completion of heating and left to be cooled or cooled in the oven. The cooling rate is usually from 0.5 to 100° C./minute, preferably from 1 to 70° C./minute, and more preferably from 1 to 50° C./minute.

Eligible ovens are conventional dry ovens or ones which circulate hot air. The interior of an oven may be inactivating atmosphere such as nitrogen and argon.

(2) Annealing Treatment Using a Hot Plate

In the case of using a hot plate, there are two methods, one of in which a cell is place on a hot plate maintained at a certain temperature and the other of in which a cell is place on a hot plate and then heated to a certain temperature. Either one of the methods may be suitably employed. The temperature on a hot plate is usually from 40 to 200° C., preferably from 50 to 150° C., and more preferably from 60 to 120 ° C. In the case of heating a cell on a hot plate maintained at a certain temperature, the time of heating is usually from 1 minute to 50 hours, preferably from 5 minutes to 30 hours, and more preferably 10 minutes to 24 hours. In the case of heating to a certain temperature, the heating rate is usually from 0.5 to 100° C./minute, preferably 1 to 60° C./minute, and more preferably 1 to 30° C./minute. In this case, the temperature once reached at a certain level may be then maintained for usually 50 hours or shorter, preferably 30 hours or shorter, and more preferably 24 hours or shorter and 0.1 hours or longer.

In either case, a cell may be removed from a hot plate immediately after the completion of heating and left to be cooled or cooled in the oven. The cooling rate is usually from 0.5 to 120° C./minute, preferably from 1 to 70° C./minute, and more preferably from 1 to 50° C./minute.

A hot plate may be placed in an air atmosphere or in a bag of inactivating atmosphere such as nitrogen and argon.

(3) Annealing Treatment Using a Halogen Lump or an Infrared or Far Infrared Lump

In the case of heating a substrate by irradiation, there are two methods, one of in which a cell is irradiated by light from a lump which is lighting in a normal state and the other of in which the illuminance of a lump to a cell is adjusted and then the cell is heated to a certain temperature. Either one of the methods may be suitably employed. In the case or irradiating with a lump lighting in a normal state, the surface temperature of a cell is usually from 40 to 160° C., preferably from 50 to 130° C., and more preferably from 60 to 100° C. The irradiation period is usually from 1 minute to 50 hours, preferably from 5 minutes to 30 hours, and more preferably from 10 minutes to 24 hours. In the case of adjusting the illuminance of a lump and the heating to a certain temperature, the heating rate is usually from 0.5 to 10° C./minute, preferably from 1 to 7° C./minute, and more preferably 1 to 5° C./minute. In this case, the temperature once reached at a certain level may be then maintained for usually 50 hours or shorter, preferably 30 hours or shorter, and more preferably 24 hours or shorter and 0.1 hour or longer.

In either case, the lump irradiation may be stopped immediately after the completion of heating or the substrate is gradually cooled by adjusting the lump illuminance. The cooling rate is usually from 0.5 to 100° C./minute, preferably from 1 to 70° C./minute, and more preferably from 1 to 50° C./minute.

The irradiation may be conducted under an air atmosphere or an inactivating atmosphere such as nitrogen or argon.

An electrochromic mirror can be produced by following the above-described procedures of the present invention. In the case where a cell containing an electrolyte precursor is subjected to the annealing treatment, the precursor may be polymerized so as to be cured after the annealing treatment.

An electrochromic mirror of which cell is improved in capabilities can be produced in accordance with the method of the present invention.

Examples of the invention will now be provided, with understanding that the invention is in no way limited by these examples.

### EXAMPLE 1

A sealant is prepared by adding 0.4 g of soda-lime glass beads having an average particle size of 53 to 63 μm to 20 g of a commercially available thermally-curing epoxy-based sealant (STRACTOBOND XN-21-S) and well-kneading them.

A cell was prepared by applying the sealant on the peripheral edge of either one of a soda-lime glass substrate with an ITO layer and a soda-lime glass substrate having on its surface an ITO layer and on the other surface an aluminum reflective layer and a protective layer formed thereon, disposed with their ITO layers facing each other and laminating the substrates on each other after spreading soda-lime glass beads having an average particle size of 53 to 63 μm over the surface of the substrate applied with the sealant using a sieve so as to be about 20 pieces/cm². A block of stainless steel was placed on the cell so as to press the cell with a force of 0.02 MPa using a spring. The cell with the force applied was put in an oven and heated at a temperature of 160° C. for 2 hours so as to cure the sealant thereby obtaining a complete cell.

Separately from this, a homogeneous solution of a polymeric solid electrolyte composition precursor containing an electrochromic compound was prepared by adding lithium perchlorate, diheptylviologen perchlorate and ferrocene to a mixed solution of 1.0 g of methoxypolyethylene glycol monomethacrylate manufactured by SHIN-NAKAMURA CHEMICAL CO., LTD. under the trade name of “M40GN”, 0.02 g of polyethylene glycol dimethacrylate manufactured by SHIN-NAKAMURA CHEMICAL CO., LTD. under the trade name of “9G”, 4.0 g of γ-butylolactone, 0.02 g of 1-(4-isopropylphenyl)-2-hydroxy-2-methylpropane-1-on, and 0.15 g of 3-(5-methyl-2H-benzotriazole-2-yl)-5-(1-methylethyl)-4-hydroxybenzene propanoic acid such that the concentration of each lithium perchlorate, diheptylviologen perchlorate and ferrocene is made 0.8 M, 30 mM, and 30 mM, respectively. The resulting solution was vacuum-injected into the above cell through the inlet. The cell was placed between two stainless steel blocks and squeezed by applying thereto a pressure of 0.01 MPa with a spring so as to discharge a portion of the electrolyte. Thereafter, a sealer was applied in the inlet. The pressure was weaken by 0.002 MPa so as to suck the sealer into the cell. The cell was irradiated to light from a infrared lump so as to cure the sealer. The electrolyte in the cell was then photo-cured.

The cell was put into an hot air circulation type oven the inside of which was maintained at 80° C. and was heated, i.e., annealed for 15 hours. Thereafter, the cell was taken out from the oven and left to be cooled down, thereby obtaining an anneal-treated electrochromic anti-glare mirror. The resulting mirror was colored uniformly over the entire cell surface and did not exhibit any change even after coloration and decoloration cycles were repeated a number of times.

### EXAMPLE 2

A cell containing sealingly a high polymer solid electrolyte was obtained by following the procedures of Example 1. The cell was placed on a hot plate maintained at 75° C., for 10 hours. Immediately thereafter, the cell was taken out from the hot plate and left to be cooled down thereby obtaining an anneal treated electrochromic anti-glare mirror. The resulting mirror was colored uniformly over the entire cell surface and did not exhibit any change even after coloration and decoloration cycles were repeated a number of times.

### EXAMPLE 3

A cell containing sealingly a high polymer solid electrolyte was obtained by following the procedures of Example 1. A halogen lump was turned on after the cell was placed thereunder. After 5 minutes passed, the surface temperature of the cell reached at 80° C. The irradiation with maintaining the surface temperature of the cell at 80° C. was continued for 20 hours. Thereafter, the lump was turned off and the cell was left to be cooled down thereby obtaining an anneal-treated electrochromic anti-glare mirror. The resulting mirror was colored uniformly over the entire cell surface and did not exhibit any change even after coloration and decoloration cycles were repeated a number of times.

### EXAMPLE 4

A cell containing sealingly a high polymer solid electrolyte was obtained by following the procedures of Example 1. The cell was connected with a controlling electric circuit and an optical sensor and then accommodated in a case. The electrochromic anti-glare mirror thus obtained was put in a hot-air circulation type oven the inside of which was maintained at 80° C. and heated for 15 hours. Thereafter, the cell was taken out from the oven and left to be cooled down thereby obtaining an anneal-treated electrochromic anti-glare mirror. The resulting mirror was colored uniformly over the entire cell surface and did not exhibit any change even after coloration and decoloration cycles were repeated a number of times.

What is claimed is:

1. A method for producing an electrochromic mirror which comprises a step of obtaining an electrochromic mirror cell by laminating two electrically conductive substrates applied with a sealant on the peripheral edge of the conductive surface; a step of sealing the cell after injecting an electrolyte therein; and annealing the cell containing the electrolyte.

2. The method according to claim 1 wherein said sealant is selected from the group consisting of thermally-curing epoxy resins and photo-curing epoxy resins.

3. The method according to claim 1 wherein said sealant contains beads having an average particle size of 200 to 20 μm in an amount of 0.01 to 10 percent by mass.

4. The method according to claim 1 wherein said sealant is applied by dispensing or screen-printing.

5. The method according to claim 1 wherein beads are spread over the surface of said substrate.

6. The method according to claim 1 wherein said electrolyte is vacuum-injected into said cell.

7. The method according to claim 1 wherein said cell is annealed at a temperature at which the low molecular weight components from said sealant diffuses or dissolve in said electrolyte and said electrolyte and other constituting parts are not changed in their nature.
